(19) United States
(12) Patent Application Publication
(10) Pub. No.: US 2002/0028267 A1
(43) Pub. Date: Mar. 7, 2002

(54) ENZYME GRANULATE FOR USE IN FOOD TECHNOLOGY

(76) Inventors: HUBERT A. HERRMANN, CREMLINGEN-WEDDEL (DE); ROLF SPANNAGL, HUSUM (DE)

Correspondence Address: KIRSTEN A ANDERSON, GENENCOR INTERNATIONAL INC, 925 PAGE MILL ROAD, PALO ALTO, CA, 943041013

(21) Appl. No.: 09/180,101

(22) PCT Filed: May 13, 1997
(86) PCT No.: PCT/US97/08172

(30) Foreign Application Priority Data
May 13, 1996 (DE) 19619222.6

(51) Int. Cl. A23L 1/10

(52) U.S. Cl. 426/18; 426/61; 426/285

(57) ABSTRACT

The production of an activitystable and low dust enzyme granulate for use in food technology applications or for working into recipes for food technology application for example, in the production of baked goods and farinaceous products, in starch processing, or in brewing, is described. The activitystable and lowdust enzyme granulates obtained according to the production methods and their use in food technology are also described. In another, special aspect of the invention, the use of especially selected flours are very generally described as an auxiliary (for example, as a carrier or filler) for the production of enzyme granulates for various application purposes.

### INTRODUCTION

The invention concerns the production of an activity-stable and low-dust enzyme granulate for use in food technology applications or for working into recipes for food technology applications, for example, in the production of baked goods and farinaceous products, in starch processing, or in brewing. The invention also concerns the activity-stable and low-dust enzyme granulates obtained according to the production method and their use in food technology. Furthermore, the invention concerns the use of especially selected flours very generally as an auxiliary (for example, carrier or filler) for the production of enzyme granulates for various application purposes.

In food technology, enzymes are variously used for different food technology applications—thus, for example, in the baking ingredient industry for baking ingredient mixtures or for the production of dough; in brewing, particularly for filtration improvement; or in starch liquefaction and alcohol production; in the processing of milk and milk derivatives, of fruits, vegetables, and wine; or very generally also for the hydrolysis of proteins, fats, or cellulose; and for the isomerization of sugars (for example, glucose isomerization), to mention only a few examples. The enzymes used can be of natural origin from plants or of animal origin, or are produced via microorganisms. The enzymes are usually used as mixtures (with main and secondary activities), as they are yielded from the individual recovery or production processes; they can, however, also be put together as enzyme mixtures of several pure individual enzymes, which is particularly the case if by means of modern genetic engineering methods, enzymes are used in pure form and in high yield or in genetically modified form—so-called site-directed mutation.

In the production of dough, particularly for baking with high-quality—that is, fully ground—flours, enzymes are traditionally used, which, for example, compensate for the lack of natural enzymes in these flours. Furthermore, a particularly favorable characteristic of the individual baking goods, for example, of a bread or a pastry, can be reinforced by enzymes. For example, amylases are used for the improvement of dough processing and β-amylases for the improvement of crispiness and dough volume; proteases are used for adhesive agent enhancement by the partial degradation of proteins; pentosanases and cellulases and hemicellulases are used with high pentosanase-containing flours, such as rye flour, for the degradation of mucins, wherein the processability and in addition, the pore formation of the bread can be improved. A particular advantage of the use of enzymes is to be found in the fact that they improve the freshness maintenance of bread or baked goods or slow down the “old baking” (as so-called antistaling agents). Lipases and oxidases are used for the enhancement of aromas, lipoxygenases for the bleaching of the crumb color. Above all in the large-scale baking industry with a quick turnover of produced baking goods, precise production methods and production conditions must be maintained in order to be able to ensure the desired specifications and quality of the baked goods. To this end, enzymes are of the greatest advantage and have been used for a fairly long time. The enzymes are mostly used in a mixture with other conditioning agents—for example, with emulsifiers, salts, such as citrates or lactates, fats, mono- and diglycerides—and in very fine particle form, adapted to the particle size of the flour, in order to ensure as homogenous a distribution as possible; the enzymes can be added in very fine particle form, but also without additional auxiliaries to a preliminary dough mixture or directly to the dough. Since the powdery enzymes are used both directly in the production of dough mixtures or indirectly in baking ingredient mixtures in very fine particle form, they can be very easily agitated and solid-aerosols can be formed, for example in regular or large-scale bakeries during normal handling, such as removal from the packaging, pouring into preliminary flour mixtures or during addition to the dough, by the addition process, but also by the effect of mechanical mixing-in tools; these solid-aerosols are deposited only slowly because of the small dimensions of the solid particles. Thus, there is the danger that enzyme-containing aerosol dust is inhaled by the persons carrying out the operations. The small dimensions of the aerosol dust particles make it possible for them to penetrate deep into the breathing organs of the affected persons and due to sensitizing effects, trigger health impairments, such as irreversible allergies. In using enzymes in other food technology applications, such as in the brewing process or in starch processing and the production of alcohol, the aforementioned disadvantages and health hazards appear in the same manner. There has been no lack of experiments, therefore, [on methods] to dedust the normally very fine-particle enzymes, for example, by the addition of very finely distributed oils, such as soybean oil or lecithin. The solubility of the enzymes, however, is reduced by the addition and the fine distribution of such oils and thus the release and effective action of the enzymes are impaired.

In brewing and in the production of alcohol, usually liquid enzyme formulations are therefore used to degrade starch from potatoes or similar starch sources in the state of the art—for example, perhaps after the prior boiling of the mash. Thus, for example, during the brewing for the raw product treatment of grains, sorghum, rice, corn, or other starch sources, amylases, proteases, β-glucanases, or their mixtures are used; in the washing process, for example, β-glucanases are used; in the storage tank, glucoamylases and proteases for the improvement of filtration characteristics or for the clarification of the material by the dissolution of substances causing turbidity. The use of liquid enzyme formulations, however, brings up several serious disadvantages. As easily perishable proteins, the enzymes and the liquid formulation frequently become useless, in particular, for example, in areas with a hot climate, and thus lose their effect. Also it is difficult—especially in the presence of protease—to formulate enzyme mixtures in such a way that all enzymes remain equally stable and so that these enzymes present in dissolved form do not lose their activity and effectiveness in the liquid formulation during their storage. It is therefore common to mix the liquid formulations with auxiliaries, wherein it remains difficult, however, to develop suitable compositions which meet the requirements of enzyme stability and enzyme effectiveness and perhaps legal or other regulations. Thus, the liquid formulations have to, as a rule, contain enzyme stabilizers and sorbates or p-hydroxyethers of benzoic acid, and exhibit high salt contents, in order to protect the formulations from spoiling microbially and to protect the enzymes contained therein from inactivation, for example, against inactivation due to the degrading effect of proteases present on other enzymes. To produce stable recipes, expensive investigations are, in part, necessary and often the stabilization of all enzymes is nevertheless incomplete. Until the use of the enzyme formulation, therefore, a large part of the enzymes have frequently become inactive already or their activity is greatly reduced, so that the sensitive and complicated interplay of the enzymes during the brewing process is persistently destroyed; this would lead to intolerable quality losses and thus complicates the use of stored enzyme mixtures in liquid form.

The task therefore was to make available a suitable method for the formulation of enzymes for use in food technology applications or for working into recipes for food technology applications, in order to eliminate the aforementioned disadvantages, such as the danger of sensitization or allergy, and in order to make possible also the use of enzyme or enzyme mixtures without the danger of inactivation or nonacceptable activity losses in food technology. The enzyme granulates should continue to be low in bacilli and dust and it should be possible to easily release the enzyme or enzyme mixture therefrom and to synthesize them with natural and ecologically advantageous raw materials and to be able to omit interfering stabilizers.

### SUMMARY OF THE INVENTION

The production of an activity-stable and low-dust enzyme granulate for use in food technology applications or for working into recipes for food technology applications, for example, in the production of baked goods and farinaceous products, in starch processing, or in brewing, is described. The activity-stable and low-dust enzyme granulates obtained according to the production methods and their use in food technology are also described. In another, special aspect of the invention, the use of especially selected flours are very generally described as an auxiliary (for example, as a carrier or filler) for the production of enzyme granulates for various application purposes.

The goal is attained by the method indicated in Claim 1, by the activity-stable and low-dust enzyme granulates according to Claim 17, produced according to this method, the uses indicated for these enzyme granulates in Claims 20 to 24, and the use of special raw materials, indicated in Claim 25. Appropriate embodiments of the method in accordance with the invention are given in Subclaims 2 to 16 and with regard to the enzyme granulate, in accordance with the invention, in Subclaims 18 to 19.

### BRIEF DESCRIPTION OF THE DRAWINGS

FIG. 1: Long-term storage stability of a pentosanase granulate, in accordance with the invention (see Example 3).

FIG. 2: Long-term storage stability of a cellulase granulate, in accordance with the invention (see Example 3).

### DESCRIPTION OF THE SPECIFIC EMBODIMENTS

Accordingly, the invention makes available, first of all, a method for the production of an activity-stable and low-dust enzyme granulate which is used in food technology applications or for working into recipes for food technology applications, wherein the method of the invention is characterized by the fact that first a moist granulate is produced, by synthesizing 0.01 to 20 parts by weight enzyme or enzyme mixture (calculated as the dry substance content of the used enzyme preparation); 80 to 99.99 parts by weight (including moisture content) of an organic flour type with a degree of grinding of 30% to 100%, wherein the flour type was obtained by the grinding of a flour source, perhaps washed and/or cleaned beforehand and treated with dry superheated steam; and wherein the parts by weight of the enzyme or enzyme mixture and the flour type add up to 100 parts by weight; perhaps up to a total of 20 parts by weight of common, enzyme- and nutrition-physiologically compatible granulation auxiliaries (calculated as anhydrous granulating auxiliaries); using a calculated quantity of water sufficient to establish a moisture content in the moist granulate of 20 to 50 wt % (based on the sum of the components of the moist granulate as 100 wt %); in a rapid mixer by intensive mixing, with at least occasional use of a knife head, to form a tack-free moist granulate with particles in the desired particle size range; perhaps by additionally rounding off the moist granulate obtained in this way before further drying the moist granulate and perhaps freeing the dried enzyme granulate from undersize and/or oversize particles by screening; and perhaps by also coating the particles of the material particle fraction of the enzyme granulate obtained by screening with one or more enzyme- and nutrition-physiologically compatible protective layers. The term “tack-free” means that the moist granulate no longer adheres to the mixing devices or to the walls of the mixer.

In an appropriate embodiment of the invention, the aforementioned method is characterized by the fact that for the production of the moist granulate, 0.01 to 10 parts by weight enzyme or enzyme mixture, 90 to 99.99 parts by weight flour type, wherein the parts by weight of the enzyme or enzyme mixture and the flour type add up to 100 parts by weight, perhaps up to a total of 15 parts by weight common enzyme- and nutrition-physiologically compatible granulating auxiliaries, and a calculated quantity of water sufficient to establish a moisture content of 25 to 40 wt % in the moist granulate are used. Preferably, for the production of the moist granulate, one uses 2 to 7 parts by weight enzyme or enzyme mixture, 93 to 98 parts by weight flour type, wherein the parts by weight of the enzyme or enzyme mixture and the flour type add up to 100 parts by weight, perhaps 0.5 to 5 parts by weight common enzyme- and nutrition-physiologically compatible granulating auxiliaries and a calculated quantity sufficient for the establishing of a moist content of 25 to 35 wt % in the moist granulate.

In accordance with the invention, organic flours (that is, flours made of organic basic substances) of a certain type are used. The designation “organic flour” hereby comprises, within the scope of the invention, all more or less, comminuted, powdery to fine-grain products, which were obtained by the comminution (grinding) of solid, organic materials of a natural origin (flour source). Appropriately, the organic flours used in the method of the invention are obtained by grinding grain particles, leguminous products, and/or products of the Malvaceae family (for example, cotton seeds). The grains preferably used as a flour source within the scope of the invention are, in particular, wheat or rye, but also barley, oats, rice, and corn, as well as sorghum and other millet types, can be used. Although buckwheat, per se, does not belong to the cereals (polygonaceous plants), their beechnut flour products can likewise be used, within the scope of the invention, as a flour source.

In another preferred variant of the invention, leguminous products or products of the Malvaceae family (cotton seeds) are used as a flour source. Leguminous plants here are understood to mean the plant nutrients (leguminous products) belonging to the fruits used as vegetables. As a flour source, within the scope of the invention, therefore, one can take into consideration the products of the leguminous genuses, such as: pisum (peas), cajamus [sic; cajanus] (pigeon pea), cicer (chick-pea), lens (lentils); phaseolus (beans), vigna (cowpeas), dolchius [sic; dolichos] (hyacinth beans) cassavalia [sic; canavalia] (sword bean), vicia (horsebeans or sweet peas); field peas; arachis (peanuts); lupines; alfalfa; soybeans and lima beans and perhaps other leguminous products; as Malvaceae products, one can take into consideration, for example, those of the genus gossypium (cotton). In this variant, leguminous plants, in particular, soybeans, are preferred. Within the scope of the invention, it was discovered here also, for the first time, that leguminous flours or flours made from the products of the Malvaceae family in general are suited, with particular preference, as an auxiliary for the production of enzyme granulates, since they develop a positive effect on the enzyme stability both of the individual enzymes as well as of enzyme mixtures and on the dust characteristics of the enzyme granulates produced with them when they are used as carriers or fillers or also when used as an additional formulation component, in addition to other common carriers and fillers; furthermore, these flours permit a simpler production of enzyme granulates, which is more gentle with the enzymes and more economical in comparison to other common carriers or fillers, not only for food technology, but also for many other industrial fields of application. The invention therefore also very generally concerns the use of leguminous flours or of flours from products of the Malvaceae family for the production of enzyme granulates for any application purposes, in particular, here, however, for the production of enzyme granulates for food technology applications or for working into recipes for those food technology applications. Among oleiferous products of the aforementioned genuses, both deoiled, partially deoiled, and oleiferous products are used for the production of the flour used in accordance with the invention; partially deoiled products, in particular partially deoiled leguminous products, for example, partially deoiled soybeans, are preferred here.

Depending on the grinding method used and the degree of grinding thereby attained in the individual case, the flours which can be used within the scope of the invention are fine flours of a yellowish white to gray-dark color (light or dark flours) or perhaps also more or less grainy (coarse meal, grit, fine grit) or white-yellowish brown mottled products. The organic flour types used in accordance with the invention usually exhibit a moisture content up to approximately 15 wt % (for example, a moisture content of 7 to 15 wt %), which should be taken into consideration in the calculation of the percentage moisture content of the moist granulate produced in the rapid mixer in accordance with the invention. Usually, grain flours are used in the invention, which exhibit a moisture content of approximately 10 to 15 wt %, in particular, 13 to 15 wt %; the flours from leguminous products or products of the Malvaceae family usually exhibit a moisture content of approximately 9±2 wt %.

Other important criteria for the characterization of the flour type used in accordance with the invention are the degree of grinding and the so-called flour type; these criteria correlate in such a way with one another that with increasing degree of grinding, the coefficient of the flour type also increases (that is, the degree of comminution or the fineness of the flour). The degree of grinding corresponds to the weight quantity of the obtained flour, based on 100 parts by weight of the used material to be ground (within the scope of the invention, that is, of the used grain or the leguminous products); it is thus a percentage flour yield. Upon grinding the flour, mostly pure, very fine flour, for example, from the interior of the cereal grain, is yielded initially and upon further grinding, that is, for example, with increasing degree of grinding, the fraction of raw fiber and shell content in the flour increases; the starch fraction is thereby lower. The degree of grinding is therefore also reflected in the so-called “flour type,” which is used as a numerical indication for the classification of flours—in particular, grain flours—and which is based on the ash content of the flour (so-called ash scale). The flour type or the type number hereby gives the quantity of ash (mineral substance) in mg, which is retained upon burning 100 g flour dry substance. With the example of grain flours, it is possible to illustrate the type number as follows: the higher the type number, the darker the flour and the higher the degree of grinding, since the core of the grain particle contains approximately only 0.4 wt % ash; the shell, on the other hand, approximately 5 wt %. A wheat flour of the 405 type thus contains, for example, 0.405 wt % ash on the average. With a lower degree of grinding, the grain flours, on the other hand, consist predominantly of the comminuted flour bodies—that is, the starch component of the grain particles; with a higher degree of grinding, the grain flours contain the comminuted, protein-containing aleurone layer of the grain particles; with coarse meal, the components of the protein- and fat-containing germ and the raw fiber- and ash-containing seed coats.

The degree of grinding of the flour used in accordance with the invention is 30 to 100%. The degree of grinding of 30% corresponds to a very fine flour; the degree of grinding of 100%, to a full-grained flour. In appropriate variants of the method of the invention, this is characterized by the fact that the degree of grinding of the flour type is 50 to 100%, preferably 70 to 100%.

The flour used in the method in accordance with the invention is characterized by the fact that it was obtained from a flour source which was subjected before the grinding to a treatment with dry superheated steam at a temperature of, in particular, 100 to approximately 110° C. under approximately normal pressure to a slight excess pressure (for example, 0.8 to 1.2 excess pressure) and a treatment time (residence time in the superheated steam treatment apparatus described below) of up to approximately 1 h. Dry superheated steam is a superheated and unsaturated water vapor, which can be produced in a conventional manner by superheating and separating any water condensation product or by the depressurizing of steam of a high pressure. The superheated steam treatment of the flour source can take place, for example, using a conical hopper that expands downwards and which is equipped with one or more annular nozzles or steam lances for the introduction of the dry superheated steam. The hopper can be coated in continuous operation with the flour source, for example, via conveyor worms and emptied via heated conveyor worms. The superheated steam-treated flour source is subsequently conditioned to a constant water content of at most 15 wt %, for example, in a downstream fluidized bed drier, and cooled for the subsequent grinding in another fluidized bed drier. The treated, cooled flour source is then continuously supplied to a grinding machine and ground to a particle size distribution with a main fraction of particle sizes in the range of 500 to 50 μm; preferably, the fraction of the particles with particle sizes smaller than 50 μm in the ground flour does not exceed 35 wt %, and the fraction of particles with particle sizes of 300 to 500 μm does not exceed 10 wt %. With an appropriate particle size distribution, the fraction of particles ≧300 μm is at most 5 wt %, of particles in the range 300 μm to 50 μm, 65 to 80 wt %, and of particles below 50 μm, at most 30 wt %.

The mixing and granulating of the components can take place in the method in accordance with the invention in an intermittently operating rapid mixer, for example, plough blade mixer type, or in a continuously operating rapid mixer, Schugi Flexomix type (manufactured by the Schugi Process Engineers Company in Lelystadt/Netherlands). A tack-free moist granulate is hereby obtained by continuously metering in water, perhaps via an enzyme solution or with an eventually added granulating auxiliary, as a function of the supply of the solid components, so that the moisture content in the moist granulate (that is, before drying) is generally 20 to 50 wt %, preferably 25 to 40 wt %, and in particular, 25 to 35 wt % at the discharge of the mixer. Solid particles for the granulate synthesis can, if desired, be premixed in the mixer up to 5 to 10 min, before the aqueous granulating liquid (for example, water or aqueous solution of components for the granulate) are admixed and granulated; at the end of the granulating time, the knife head of the mixing apparatus is turned on for a few more minutes. According to the method of the invention, a moist granulate with a particle size range of 50 to 800 μm, preferably 50 to 500 μm, is synthesized in this manner. The mixing time in the rapid mixer, or with continuous mode of operation, the average residence time, is, as a rule, up to a maximum of 15 min with the method of the invention; the specialist can hereby adapt the mixing time or residence time to the desired characteristics of the moist granulate (for example, freedom from tackiness, particle sizes) or to the pertinent mixer. Time periods of approximately 2 min to 10 min, in particular 3 to 8 min, have proved sufficient as appropriate mixing or residence times with intermittent granulation; if desired, however, up to several minutes more mixing can be carried out, using the knife head in order to improve the granulate particle. With a continuous mode of operation, substantially shorter average residence times are sufficient in the mixer; thus in a continuous mode of operation in the rapid mixer of the Schugi Flexomix type the average residence time, dependent on the apparatus size and on the quantity flow, is only in the range of a few seconds, for example, up to 30 sec, in particular 1 to 10 sec. Subsequently, for the further rounding out of the granulate particle, the moist granulate can perhaps be shaped in a rounding device, preferably in a rotary table apparatus or a so-called Marumerizer®, by rerolling during, for example, a time period of 0.5 to 10 min, preferably 0.5 to 5 min. Following the granulation, the moist granulate is subjected to a conventional drying which is gentle to the enzyme, for example, in a fluidized bed drier, and dried to form a granulate with a desired moisture content, in particular a moisture content of 3 to 12 wt %, preferably 7 to 9 wt %. The dried granulate can, if desired, be freed from oversize and undersize particles by screening, wherein the particles separated from the material particle fraction can be ground and recycled to the granulation process. Any very fine dust particles can thereby be removed by screening also, for example, on a compressed air screen; perhaps the screening can also take place, or if desired, repeated only after a coating of the granulate particles with one or more protective coatings.

In a special specific embodiment of the method of the invention, the powdery components for the enzyme granulate, perhaps present premixed, are intermittently or continuously supplied to the rapid mixer and then likewise, intermittently or continuously, a quantity [of water] suitable for the establishment of the moisture content or a suitable quantity of an aqueous solution, perhaps with granulating and/or formulating auxiliary substances dissolved therein or an enzyme or enzyme mixture dissolved therein, is metered in, and after a prespecified residence time, the moist enzyme granulate is removed from the rapid mixer or it is continuously drawn off. An appropriate procedure in this method variant is characterized by the fact that of the components for the enzyme granulate, only the flour type is supplied in powdery form, intermittently or continuously, to the rapid mixer and then likewise, intermittently or continuously, an aqueous enzyme solution with an enzyme or enzyme mixture content coordinated with the flour quantity and with an amount of water suitable to establish the moisture content is metered in.

As granulating auxiliaries, enzyme-compatible and nutrition-physiologically safe binders, filler, thickeners, and/or organic solvents can be used in the method of the invention. Appropriate binders are, in particular, degraded soluble starch and/or wheat gluten.

After the drying, the finished enzyme granulate, if necessary, can also be coated with a common lacquer, film, or another coating, in a manner that is, in fact, common. The coating or the lacquer can thereby optionally contain another enzyme or, however, serve to dye the granulate, or also to bring about a retardation of the release of the enzyme or enzyme mixture. The lacquer or film or the coating can be applied on the enzyme granulate, both continuously as well as intermittently. The uncoated enzyme granulate cores produced according to the method of the invention can thus be coated with one or more enzyme- and nutrition-physiologically compatible protective layers, wherein, the quantity of the protective layer components (as dry substance) is preferably, however, only 1 to 20 wt %, based on the uncoated enzyme granulate as 100 wt %. As protective layers, one can, in particular, take into consideration the materials usually used in the food industry or, for example, pharmaceutical coatings also, for example, for dragee syrups, optionally also with dragee powder (for example, from talc, optionally in a mixture with sugar powder); films or lacquers based on cellulose derivatives (for example, methylcellulose, hydroxypropyl methylcellulose), polyacrylates or polymethacrylates or vinyl polymers, such as polyvinylpyrrolidone or polyvinyl acetate phthalate. Other common coating auxiliaries can be added to the coating materials also, for example: binders (for example: gelatin), lubricants or dispersants, brighteners, and covering and coloring agents (for example, white or color pigment), drying agents for the improvement of the adhesion characteristics and structure formation (for example, colloidal silica gel), plasticizers, etc. The coating materials can be applied on the granulate cores in a manner which is, in fact, common, using the solvents usual for it.

In the method of the invention, all enzymes which can be normally employed in food technology can be used. The enzyme can be both an isolated, pure enzyme (that is, without secondary activities) or a mixture of enzymes. An enzyme mixture can be compiled from pure enzymes without secondary activities or, however, can be obtained in a simple way, directly in the form of an enzyme mixture yielded through the process during the production of an enzyme from microorganisms or also from plant and animal materials; such enzyme mixtures yielded through the process as a function of the microorganism or the plant or animal material comprise, as a rule, various accompanying enzymes (so-called secondary activities), in addition to one main enzyme, which, as a rule, evolve a favorable synergistic secondary effect. The enzyme or enzyme mixture can thus generally be a hydrolase, preferably from the group of the carbohydrases, proteases, lipases, and esterases, or an oxidase, or a mixture thereof. The carbohydrases for the method of the invention are, for example, selected from β-glucanases, cellulases, amylases, pentosanases (for example, endopentosanases), pectinases, xylanases. Within the scope of the invention, other enzymes, for example, arabanases, hemicellulases, galactomannanases, polygalacturonases, phytases, glucoamylases, β-galactosidases, pullulanases, Driselase®, and so on can be used. If oxidases are used, then they can be glucose oxidases, lipoxygenases, or peroxidases. Examples of proteases of plant origin are, for example, proteinases, such as papain and bromelan, and of animal origin, for example, proteinases from the pancreas; the aforementioned proteinases of plant or animal origin are natural enzyme mixtures with a proteolytic main activity and various secondary activities. The fraction (the quantity) of the enzyme or enzyme mixture introduced into the granulate depends on the individual, specific enzyme activity and the desired activity in the finished enzyme granulate. For example, pentosanase, as a rule, has a high specific activity and can ensure a sufficient enzyme activity in the finished enzyme granulate, even in quantities of 0.01 to 0.1 part by weight. To produce the enzymes or enzyme mixtures by means of microorganisms, generally bacteria, especially from the genus pseudomonas or bacillus, or fungi, especially from the genus aspergillus, trichoderma, rhizopus, penicillium, irpex, are used. It is also possible, if desired, to clone and to express the structural genes of the enzymes into suitable strains of microorganisms. To this end, any microorganism which absorbs the DNA to be cloned for the enzyme by plasmid (episomally) or genomically (chromosomally) and can carry out the appropriate functions is, in fact, suitable.

The enzyme or enzyme mixture used in the method of the invention can be used in the form of a powder or an aqueous solution of the enzyme or enzyme mixture. Appropriate enzymes or enzyme mixtures are hereby enzyme preparations as they are usually yielded during industrial production. As a rule, such enzyme preparations contain not only a single enzyme or a mixture of enzymes, but also other production-determined accompanying substances in minor quantities. An example of such accompanying substances concerns, for example, salts added to the precipitation of the enzyme from the mother liquor, as it is obtained after separation of the biomass from a fermentation solution and during the precipitation, can be partially enclosed by the enzyme precipitate. The enzymes or enzyme mixtures can also contain the usual enzyme stabilizers and extenders and preservatives as additional accompanying substances. Examples of such accompanying substances are sodium benzoate, calcium salts, glucose, parabene, calcium salt, glucose, paraben, potassium and sodium sorbate, common salt. If aqueous solutions of the enzyme or enzyme mixture are used, then they are prepared by a subsequent dissolution of enzyme or enzyme mixture powders; or in another variant, the mother liquors, as they are yielded after separation of the biomass from the fermentation solution, can be used directly, perhaps after concentration or dilution. As a rule, those aqueous solutions of the enzymes or enzyme mixtures also contain a small fraction of production-determined accompanying substances, in addition to the actual enzyme activity or in addition to the various enzyme activities in enzyme mixtures. Enzyme mixtures can be obtained, on the one hand, directly by fermentation, wherein then the enzymes usually formed by the microorganism used are present in natural quantitative proportions, mixed with one another. Enzyme mixtures, however, can also be produced, on the other hand, by a simple mixing of individual commercial enzymes.

The invention also concerns the enzyme granulates produced according to the method of the invention, which are activity-stable and low in dust and are particularly suited for use in food technology applications or for working into recipes for food technology applications. Such enzyme granulates, in accordance with the invention, are also characterized, in particular, by the fact that they consist of a granulate core with the following composition: 0.08 to 22 wt % (dry substance) enzyme or enzyme mixture, 55 to 96.92 wt % (dry substance without moisture) of a flour type with a degree of grinding of 30% to 100%, wherein the flour type was obtained by grinding with a flour source treated with dry superheated steam, perhaps to a total 18.5 wt % enzyme- and nutrition-physiologically compatible granulating auxiliaries (calculated as anhydrous substance), and 3 to 12 wt % moisture, wherein the sum of the components of the granulate core (that is, enzyme or enzyme mixture, flour-dry substance moisture, and perhaps granulating auxiliaries) is 100 wt %; and perhaps one or more protective layers enclosing the granulate core. If the enzyme granulates, in accordance with the invention are coated with one or more protective layers, then the quantity of the protective layer components (as dry substance) is preferably only 1 to 20 wt %, based on the uncoated granulate core as 100 wt %.

Appropriate enzyme granulates, in accordance with the invention, have a granulate core consisting of 0.08 to 11 wt % (dry substance) enzyme or enzyme mixture, 66 to 96.92 wt % (dry substance without moisture) of a flour type with a degree of grinding of 30% to 100%, wherein the flour type was obtained by grinding a flour source perhaps treated with dry superheated steam, perhaps a total of 14.5 wt % enzyme- and nutrition-physiologically compatible granulating auxiliaries (calculated as anhydrous substance), and 3 to 12 wt % moisture, wherein the sum of the components of the granulate core (that is, enzyme or enzyme mixture, flour-dry substance moisture and perhaps granulating substances) is 100 wt %. Particularly preferred enzyme granulates, in accordance with the invention, have a granulate core made of 1.9 to 7.8 wt % (dry substance) enzyme or enzyme mixture, 76 to 94.6 wt % (dry substance without moisture) of the aforementioned flour type with indicated degree of grinding and origin or pretreatment, all total of 0.5 to 5.4 wt % enzyme- and nutrition-physiologically compatible granulating auxiliaries (calculated as anhydrous substance), and 3 to 12 wt % moisture, wherein the sum of the components of the granulate core is 100 wt %, based on the uncoated granulate particles.

With regard to the flour component, particularly advantageous enzyme granulates described above, in accordance with the invention, are advantageously based on leguminous flours or flours from products of the Malvaceae family, as they have already been described in detail further above.

The method, in accordance with the invention, makes available advantageous, activity-stable, and low-dust enzyme granulates for food technology applications or for working into recipes for food technology applications. The enzyme granulate prepared in accordance with the invention exhibits various advantages with regard to further processing. On the one hand, it exhibits an extraordinary thermostability, pressure stability, and friction stability. This makes it possible to overcome disadvantages of the state of the art. The enzyme granulate in accordance with the invention makes available the enzymes in a form which enables them to overcome high stresses also during storage and further processing without serious activity losses. In addition to the good loading capacity during storage and further processing, the enzyme granulate in accordance with the invention exhibits a number of other favorable characteristics. Thus, the enzyme granulates in accordance with the invention exhibit not only a favorable storage stability, but also exhibit an extraordinarily low microbe contamination, which is negligible in any case. They are free-flowing and therefore exhibit a good pouring and metering capacity. Moreover, they do not exhibit any caking tendency or any tendency to form dust according to the test methods common in food technology. The enzyme granulate, in accordance with the invention, also has an advantageous particle size adjustment, wherein, in particular, a favorable capacity for mixing and processing of baking ingredient mixtures and other powdery recipes or preliminary mixtures into the recipe components is ensured; the enzyme granulate particles in accordance with the invention do not thereby exhibit any tendency toward segregation and can therefore be processed well and in particular, for example, evolve their effect optimally in doughs, for example, in bread and other baked goods; in particular, the enzymes are released from the enzyme granulates in accordance with the invention in a surprisingly fast manner when they are used.

In another aspect, the invention therefore also concerns the direct use of the enzyme granulates, in accordance with the invention, in food technology applications or for working into recipes and preliminary mixtures for such applications: for example, the working in of the enzyme granulates for the production of, for example, powdery or granular baking ingredient mixtures. Other uses of the enzyme granulates, in accordance with the invention, concern their use in brewing, in particular for the improvement of the filtration characteristics of the brewing material, and their use in starch liquefaction and, in particular, the production of alcohol.

### EXAMPLES

The examples below are supposed to explain the aforementioned invention in more detail, without, however, limiting it in its scope.

### Example 1

Flour production (superheated steam treatment and grinding). The superheated steam treatment of the flour sources (whole grain particles or leguminous products) is carried out in a sterilization unit with the following structure:

steam-heated preheating screw, temperature approximately 40° to 50° C.;

heat-insulated and continuously operating steamer (vertically standing conical cylinder with a height of 5 m; diameter above approximately 40 cm, below approximately 60 cm; temperature approximately 100° to 110° C.);

3 steam annular nozzles in the upper region of the steamer and in the lower region, 3 vertically arranged steam lances;

steam-heated delivery worm;

a downstream fluidized bed drier and a fluidized bed cooler connected to it.

The grain or leguminous particles are continuously transported by means of the steam-heated preheating worm, into the conical steamer. There, the impingement with dry superheated steam (reduced from 8 to 0.8 excess pressure) took place via the three annular nozzles and the three steam lances. The material temperature in the steamer was approximately 100° C.; the residence time, approximately 40 min. The discharge of the treated grain or leguminous grains took place via a steam-heated worm, through which the treated material was transferred into a fluidized bed drier for the removal of steam and perhaps during the treatment of the condensed product formed. After cooling in a connected, cooling fluidized bed, the grinding of the treated grain or leguminous particles took place in a classical manner until the desired degree of grinding was attained.

The flours obtained after the superheated steam treatment exhibit the following average characteristics: moisture, approximately 10 to 15 wt % (±2 wt %); total microbe count below 100/g; 25 g samples were negative with regard to E. coli, salmonella, Pseudomonas aeruginosa; likewise, it was not possible to detect yeast and mold.

The superheated steam-treated flours in accordance with the invention thus exhibit an excellent microbiological purity. This high microbiological purity was maintained even with high degrees of grindings (high shell fraction in the flour). The flours treated in accordance with the invention were excellent for the subsequent granulation of enzymes under mild conditions, in particular under conditions without thermal treatment or without thermal or chemical microbe count reduction.

### Example 2

Production of enzyme granulates in accordance with the invention. For the production of enzyme granulates, in accordance with the invention, for food technology applications or for working into recipes for these applications, conventional enzyme preparations and leguminous flours obtained according to Example 1 were produced by the agglomeration of a powdery starting mixture with the addition of granulating liquid. The leguminous flour was intensively mixed in an intermittently operating plough blade mixer/agglomerator (Lödige mixer with knife head), with the spraying in of an enzyme-containing, aqueous granulating liquid, and the granulate formed was subsequently dried in a continuous fluidized bed drier. Undersize particles (<50 μm) and oversize particles (in particular >1000 μm) were screened out.

The aqueous liquid enzyme concentrates used were composed as follows from the components indicated: a) enzyme concentrate of a protease of the subtilisin 309 type: 13 wt % enzyme protein, 26.8 wt % inactive protein plus remaining sugar and other accompanying substances and components, remaining water to 100 wt %; activity 1,984,000 DU [Delft units]/g, total dry substance content, 39 to 39.8 wt %; b) enzyme concentrate of an α-amylase (of the Optiamyl® type, manufacturer Solvay Enzymes GmbH & Co. KG, Nienburg/Germany; origin strain Bacillus licheniformis): 18 wt % enzyme protein, 21.6 wt % inactive protein plus remaining sugar and other accompany substances and components, remaining water to 100 wt %; activity 1,023,000 MWU {Modified Wohlgemuth unit]/g, total dry substance content 39.6 wt %.

As flour, fine pea flour or fine soybean flour with a degree of grinding of 90% was used in this example. The specification of the particle size distribution of the used fine pea or soybean flours (measurement by means of the laboratory compressed air screen Alpine A 200 LS) exhibited a very narrow particle size distribution below 150 μm with a very fine quality: Fine pea flour: 64 wt %<36 μm. Fine soybean flour: 49 wt %<36 μm. The soybean flour was completely deoiled; the flours exhibited a moisture of 9.4 wt %.

The powdery discharge mixture of flour used in the granulation method was granulated with an aqueous spray solution of enzyme concentrate, containing the indicated protease or α-amylase. As an apparatus, a 5-L Lödige mixer with knife head, a hose pump (without nozzle) and a fluidized bed drier were used.

A coating in a quantity of 20 wt %, based on the uncoated granulate, was applied in a fluidized bed method on some of the granulate particles obtained.

Nicely rounded enzyme granulates (without agglomeration formation by the caking together or lump formation of the granulate particles) with excellent microbiological quality, in accordance with specifications regarding particle size distribution and activity, and with very good technological granulate characteristics were produced. It was possible to clearly further improve—that is, lower—the dust values measured in the following experiments according to the E-test (=elutriation test), if desired, by a further screening on a compressed air screen (for example, from the Alpine Company with screening of suitable μm dimensions). The measured Heubach enzyme dust values remain on the very low level—for example, with uncoated enzyme granulates of approximately 0.12 mg/20 g at the detection limit.

Experiment 2.1: Granulation of Protease with Fine Pea Flour

Recipe

Carrier material—Fine pea flour, 7.0 kg

Enzyme concentrate (granulating liquid)

Protease of the subtilisin 309 type; aqueous liquid concentrate; Activity 1,984,000 DU/g; dry substance content, 39.8 wt %, 2.706 kg

Experiment execution and time lapse

| | | |
|---|---|---|
| Premixing carrier | without knife head | 10 min. |
| Granulation | with knife head | 5 min. |
| | spraying in of concentrate | 8 min. |
| | | 9 min. |
| Remixing after exposure | with knife head | 0.5 min. |
| of dead angle | | |
| Drying | supply air temperature | 80° C. |
| | product temperature | 40° C. |

Product characteristics

| | | 2.1 b | Comparison |
|---|---|---|---|
| | | Base granulate | Base granulate |
| | | from 2.1 a | (unlacquered) |
| | 2.1 a | and 20 | from extruder |
| Experiment no. | Base granulate | wt % coating | process with same |
| Granulate | (unlaquered) | lacquer | enzyme content |
| Bulk density | | approx. 730 g/l | |
| Moisture | 9.2 wt % | | |
| Activity | 820,000 DU/g | 720,400 DU/g | 860,000 DU/g |
| Heubach total | 123 mg/20 g | 48 mg/20 g | 99 mg/20 g |
| dust | | | |
| Heubach enzyme | 7.5 mg/20 g | 2.0 mg/20 g | 80 mg/20 g |
| dust | | | |
| E-test | 31,000 DU/60 g | 200 DU/60 g | |
| Solubility 1 min. | 54% | 86% | 54% |
| Solubility 2 min. | 68% | 94% | 84% |
| Solubility 3 min. | 92% | 95% | 95% |
| Solubility 5 min. | 99% | 100% | 100% |
| Material particles | 80 wt % | 100 wt % | 100 wt % |
| 50-1000 μm | | | |
| Oversize particles | 17 wt % | 0 wt % | 0 wt % |
| >1000 μm | | | |
| Undersize | 3 wt % | 0 wt % | 0 wt % |
| particles <50 μm | | | |
| Half-life in | not determined | 4.2 days | 1.8 days |
| storage⁽¹⁾ | | | |

⁽¹⁾Conditions: 42° C. 80% relative air humidity

Experiment 2.2: Granulation of an α-amylase with Fine Soybean Flour

Recipe

Carrier material—Fine soybean flour, 7.0 kg

Enzyme concentrate (granulating liquid)

Aqueous enzyme concentrate; Activity 1,023,000 MWU/g; dry substance content, 39.6 wt %

Additional water: 0.82 kg

Experiment Execution and Time Lapse

Experiment execution and time lapse

| | | |
|---|---|---|
| Premixing carrier | without knife head | 1 min. |
| Granulation | with knife head | 8.7 min. |
| | spraying in of concentrate | |
| | spraying in of water | 3 × 1 min. |
| Remixing after exposure | with knife head | 1 min. |
| of dead angle | | |
| Drying | supply air temperature | 80° C. |
| | product temperature | 40° C. |

Product Characteristics

Product characteristics

| Experiment number | 2.2 a | 2.2 b |
|---|---|---|
| Granulate | Base granulate | Base granulate from 2.2a |
| | (unlacquered) | and 20 wt % coating |
| | | lacquer |
| Bulk density | | 761 g/l |
| Moisture | 9.4 wt % | |
| Activity, amylase | 401,000 MWU/g | 363,000 MWU/g |
| Heubach total dust | — | 12 mg/20 g |
| Heubach enzyme dust | 0.11 mg/20 g | 0.14 mg/20 g |
| Solubility 1 min | — | 30% |
| Solubility 2 min | — | 70% |
| Solubility 3 min | — | 90% |
| Solubility 5 min | — | 100% |

In Experiments 2.1 to 2.2 above, the meanings are as follows:

Heubach-enzyme dust=The Heubach dust measurement is used for the determination of abrasion dust. The dust is produced from the sample by the mechanical effect of steel balls in a dust pot. Particles smaller than 50 μm are discharged by a controlled, dry air flow and collected on a filter and weighed. In the case of enzyme-containing samples, the enzyme activity caught by the filter can also be measured in the usual manner and be indicated in the corresponding enzyme unit, based on the sample quantity used.

E-test=Elutriation test=Air flows through a granulate bed at a controlled air rate for a specified time and the loosened dust is collected in a wash flask. The content of dissolved enzyme is subsequently determined with the determination method for the enzyme activity to be investigated and indicated in the corresponding enzyme unit, based on the test quantity of the granulate in g.

DU=The activity of the proteases processed in the enzyme granulates was determined in Delft units (DU). 1000 DU correspond to the proteolytic activity, which with a volume of 1 mL of a 2% enzyme solution (w/w) after degradation of casein, produces an extinction difference (1 cm light path; 275 nm; determination against a blank test) of 0.400.

MWU=Modified Wohlgemuth units; the enzyme quantity which, under the test conditions, degrades 1 mg soluble starch in 30 min to form a dextrin of defined magnitude is measured.

The solubility was determined as follows:

In a 400-mL beaker, 200 mL of an aqueous 2% sodium polyphosphate solution were stirred at 22° C. with a mechanical blade mixer at a constant rotating speed of 700 rpm. The solution had a water hardness degree of 15° Hardness.

Avoiding the formation of lumps, 1 g enzyme granulate was added to the stirred solution. After 2, 3, and 5 min, samples were taken, which were suctioned through a nutsch filter (filter paper: Schleicher und Schüll 589). Then the pertinent enzymatic activity was determined in the filtrates. The protease activity determined in the filtrates (measured in DU) was based on the enzyme activity contained in the added enzyme granulates, wherein the starting activity in 1 g enzyme granulate corresponds to 100% protease activity. The amylase activity (measured in MWU) was determined analogously.

### Example 3

For the production of enzyme granulates in accordance with the invention for food technology applications or for working into recipes for these applications, solid enzyme preparations and grain flours obtained according to Example 1 were granulated by producing a powdery starting mixture and the subsequent agglomeration with the addition of granulating liquid.

The powder and a sprayed-in granulating liquid were intensively and thoroughly mixed in a continuous rapid mixer of the Flexomix type (Schugi Company), and the formed granulate was subsequently dried in a continuous fluidized bed drier.

Undersize particles<100 μm were blown out in a fluidized bed drier (air classification); oversize particles>800 μm, screened out and ground. The outsize particles were completely recycled.

The preliminary mixture consisted of>95 wt % coarse-grained wheat flour as the carrier and<5 wt % enzyme concentrate powder. The spray solution was a 4 to 10 wt % aqueous solution of a modified starch.

The following enzyme preparations were used:

| | | | Cellulose | |
|---|---|---|---|---|
| | Pentosanase Preparation | | Preparation | |
| Enzyme* | Activity** | | Activity** | |
| Pentosanase | 1,030,000 | EU/g | 160,000 | EU/g |
| | (Control activity) | | | |
| beta-Glucanase | 350 | EU/g | 720 | EU/g |
| alpha-Amylase | 8,800 | EU/g | 107,000 | EU/g |
| Galactomannanase | 4,300 | EU/g | 13,300 | EU/g |
| Cellulase | 16,000 | EU/g | 30,900 | EU/g |

(control activity)
*=“Natural,” that is, main and accompanying enzymes originating in the production process
**=Enzyme activity units according to stipulated standard determination methods

As a flour, coarse-grained wheat flour with a degree of grinding of 100% was used in this example. The specification of the particle size distribution of the coarse-grained wheat flour used (measurement by means of a laboratory compressed air screen Alpine A 200 LS) was as follows (average values):

| Particle size range | Wt % fraction (specification) |
|---|---|
| ≧ 300 μm | approx. 4 |
| < 300 to ≧ 250 μm | approx. 10 |
| < 250 to ≧ 200 μm | approx. 10 |
| < 200 to ≧ 150 μm | approx. 15 |
| < 150 to ≧ 100 μm | approx. 15 |
| < 100 to ≧ 50 μm | approx. 20 |
| < 50 μn | approx. 26 |

For the granulation, it proves advantageous if the fine fraction ( <50 μm) of the used flour is maintained as low as possible (for example, in particular below 30 wt %).

The powdery starting mixture of enzyme preparation and flour used in the granulation method consisted of 95 weight fractions coarse-grained wheat flour as the carrier and 5 weight fractions enzyme concentrate powder. The powdery starting mixture was agglomerated with an aqueous spray solution, containing 4 wt % dissolved, modified starch. Other examples of method conditions can be seen in Table I; the product characteristics of the enzyme granulates obtained thereby, in accordance with the invention, can be found in Table II.

Under minimal mass losses (<3 wt %) enzyme granulates with excellent microbiological quality, in accordance with specifications and with respect to particle size distribution and activity with very good technology particle characteristics.

TABLE I
Method conditions for the production of an enzyme granulate, in
accordance with the invention.

| | Pentosanase granulate | | Cellulase granulate | |
|---|---|---|---|---|
| | Mass flow | Moisture | Mass flow | Moisture |
| | kg/h | wt % | kg/h | wt % |
| Belt weigher upstream | 550 | 13.1 | 550 | 13.1 |
| from the Schugi mixer | | | | |
| 4% Starch solution | 125 | 96.0 | 115 | 96.0 |
| Discharge Schugi mixer | 675 | 29.1 | 665 | 26.3 |
| Recylate undersize | 118 | 11.6 | 92 | 10.6 |
| particles (fluidized bed | | | | |
| drier) | | | | |
| End product | 403 | 7.9 | 443 | 7.6 |

| | | |
|---|---|---|
| Mass yield (moisture- | 98 Wt % | 97 Wt % |
| corrected) | | |
| Product temperature in | | |
| the fluidized bed-drier | | |
| Segment 1 | 50° C. | 52° C. |
| Segment 2 | 48° C. | 50° C. |
| Segment 3 | 53° C. | 52° C. |
| Segment 4 | 55° C. | 56° C. |
| Number of revolutions, | 3378 rpm* | 3484 rpm* |
| Flexomix | | |

*rpm = Revolutions per minutes (= UpM)

TABLE II
Product characteristics of the enzyme granulates in accordance with
the invention.

| | Pentosanase granulate | Cellulase granulate |
|---|---|---|
| Activity | 3160 EPU/g¹⁾ | 1264 CU/g²⁾ |
| Bulk density | 532 g/l | 500 g/l |
| Dustvalue | 0* | 0* |
| Flow factor | 28* | 56* |
| Caking factor | 0* | |
| Particle size distribution, | | |
| end product | | |
| >800 μm (Oversize | 0% | 0% |
| particles) | | |
| >500-800 μm | 26% | 21% |
| >250-500 μm | 52% | 57% |
| 50-250 μm | 21.2% | 22.1% |
| Microbe counts, end | | |
| product | | |
| Total microbe count | 2000/g | 1700/g |
| Coliform | <30/g | <30/g |
| E. coli | neg. in 25 g | neg. in 25 g |
| Salmonella | neg. in 25 g | neg. in 25 g |
| Pseudomonas aeruginosa | neg. in 25 g | neg. in 25 g |
| Yeast | <200/g | <200/g |
| Mold | <200/g | <200/g |

*Criteria with regard to technological granulating characteristics
(Measurement according to standard methods):
Dust value 0-2: Dust free
Flow factor >10: Free-flowing
Caking test <5: Low caking tendency
¹⁾EPU + Activity which produces a relative fluidity change of 1 in 1 min in a defined oat shell dextran.
²⁾CU = Activity which produces a relative fluidity change of 1 in 5 min in a carboxymethylcellulose substrate.

The long-term storage stability of the enzyme granulates produced in this example was determined under the following conditions: 25° C., 60% relative air humidity, storage in polyethylene bags.

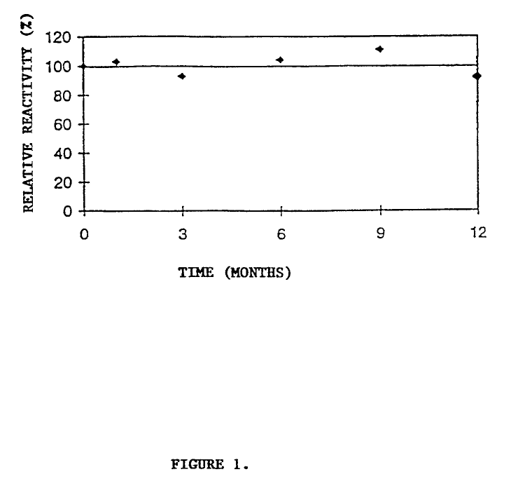

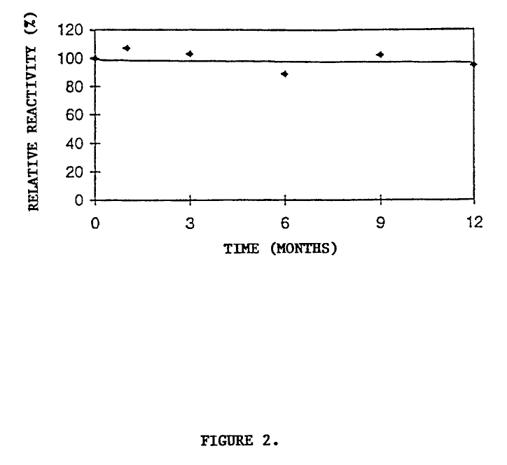

The results are given in FIGS. 1 and 2 and show the excellent long-term storage stability of the enzyme granulates in accordance with the invention over 12 months. Within the scope of measurement accuracy, essentially no activity losses were observed.

If reference was made in this application to enzyme activities, the activity determination for the pertinent enzyme was carried out according to the usual standard methods with which the specialist is familiar.

What is claimed is:

1. Method for the production of an activity-stable and low-dust enzyme granulate for use in food technology applications or for working into recipes for food technology applications, characterized by the fact that a moist granulate is initially produced by synthesizing 0.01 to 20 parts by weight enzyme or enzyme mixture (calculated as dry substance content of the used enzyme preparation), 80 to 99.99 parts by weight (including moisture content) of an organic flour type with a degree of grinding of 30% to 100%, wherein the flour type was obtained by grinding a flour source treated with dry superheated steam; and wherein the parts by weight of the enzyme or enzyme mixture and the flour type add up to 100 parts by weight; if desired up to a total 20 parts by weight enzyme- and nutrition-physiologically compatible granulation auxiliaries (calculated as anhydrous granulation auxiliaries), using a calculated quantity of water, sufficient to establish a moisture content in the moist granulate of 20 to 50 wt % (based on the sum of the components of the moist granulate as 100 wt %); in a rapid mixer by intensive mixing, with at least occasional use of a knife head to form a tack-free, moist granulate with particles in the desired particle size range; by perhaps additionally rounding off the moist granulate obtained in this way before further drying the moist granulate and if desired, freeing the dried enzyme granulate by screening undersize and/or oversize particles; and perhaps by also coating the particles of the material particle fraction of the enzyme granulate obtained by screening with one or more enzyme- and nutrition-physiologically compatible, protective layers.

2. Method according to claim 1, characterized by the fact that for the production of the moist granulate, 0.01 to 10 parts by weight enzyme or enzyme mixture, preferably 2 to 7 parts by weight enzyme or enzyme mixture, 90 to 99.99 parts by weight flour type, preferably 93 to 98 parts by weight flour type, if desired up to a total of 15 parts by weight, preferably 0.5 to 5 parts by weight granulating auxiliaries, and a calculated quantity of water sufficient to establish a moisture content of 25 to 40 wt %, preferably 25 to 35 wt %, are used.

3. Method according to claim 1, characterized by the fact that the degree of grinding of the flour type is 50 to 100%, preferably 70 to 100%.

4. Method according to claim 1, characterized by the fact that to obtain the flour type, grain particles, leguminous products, and/or products of the Malvaceae family are used as the flour source.

5. Method according to claim 1, characterized by the fact that the treatment of the flour source with dry superheated steam was carried out at a temperature of in particular 100° to approximately 110° C., under approximately normal pressure up to a slight excess pressure and a treatment time of up to approximately 1 h.

6. Method according to claim 1, characterized by the fact that a moist granulate with a particle size range of 50-800 μm, preferably 50 to 500 μm, is synthesized.

7. Method according to claim 1, characterized by the fact that the powdery components for the enzyme granulate, perhaps present premixed, are added intermittently or continuously to the rapid mixer, and likewise intermittently or continuously, a quantity of water suitable for the establishment of the moisture content, or a suitable quantity of an aqueous solution, perhaps with granulating auxiliaries dissolved therein, or enzyme or enzyme mixture dissolved therein, are metered in, and after a prespecified residence time, the moist enzyme granulate is removed from the rapid mixer or it is continuously drawn off.

8. Method according to claim 7, characterized by the fact that of the components for the enzyme granulate, only the flour type is added in powder form, intermittently or continuously, to the rapid mixer and then likewise, intermittently or continuously, an aqueous enzyme solution with an enzyme or enzyme mixture content, correlated to the flour quantity, and a quantity of water suitable for the establishment of the moisture content, are metered in.

9. Method according to claim 1, characterized by the fact that the enzyme granulate is coated with one or more enzyme- and nutrition-physiologically compatible protective layers, wherein the quantity of the protective layer components (as dry substance) is preferably 1 to 20 wt %, based on the uncoated enzyme granulate as 100 wt %.

10. Method according to claim 1, characterized by the fact that the enzyme or enzyme mixture is used in the form of a powder or an aqueous solution of the enzyme or enzyme mixture.

11. Method according to claim 1, characterized by the fact that the enzyme or enzyme mixture is a hydrolase, preferably from the group of carbohydrases, proteases, lipases, and esterases, an oxidase, or a mixture thereof.

12. Method according to claim 11, characterized by the fact that a mixture of individual enzymes or a natural enzyme mixture (enzyme with secondary activities) of microbial, plant, or animal origin is used.

13. Method according to claim 11, characterized by the fact that the carbohydrases are selected from β-glucanases, cellulases, amylases, pentosanases, pectinases, xylanases, hemicellulases, galactomannanases, polygalacturonases, phytases, arabanases, glucoamylases, α-galactosidases, pullulanases, Driselase®.

14. Method according to claim 11, characterized by the fact that the oxidases are glucose oxidases, lipoxygenases, or peroxidases.

15. Method according to claim 1, characterized by the fact that enzyme- and nutrition-physiologically compatible binders, fillers, thickeners, and/or organic solvents (of natural origin) are used as granulating auxiliaries.

16. Method according to claim 15, characterized by the fact that degraded, soluble starch and/or wheat adhesives are used as binders.

17. Activity-stable and low-dust enzyme granulate for use in food technology applications or for working into recipes for food technology applications, characterized by the fact that the enzyme granulate can be obtained according to a method of claims 1 to 16.

18. Enzyme granulate according to claim 17, characterized by the fact that it consists of a granulate core with the composition 0.08 to 22 wt % (dry substance) enzyme or enzyme mixture, 55 to 96.92 wt % (dry substance) of a flour type with a degree of grinding of 30 to 100%, wherein the flour type was obtained by the grinding of a flour source treated with dry superheated steam; perhaps up to a total of 18.5 wt % enzyme- and nutrition-physiologically compatible granulating auxiliaries (calculated as anhydrous substance); 3 to 12 wt % moisture, wherein the sum of the preceding components of the granulate core is 100 wt %; and perhaps of one or more protective layers enveloping the granulate core.

19. Enzyme granulate, according to claim 18, characterized by the fact that the quantity of the protective layer components (as dry substance) is 1 to 20 wt %, based on the uncoated granulate core as 100 wt %.

20. Use of enzyme granulates according to one of claims 17 to 19 in food technology applications or for working into recipes for food technology applications.

21. Use according to claim 20, characterized by the fact that the enzyme granulates are used for the production of baking ingredient mixtures.

22. Use according to claim 20, characterized by the fact that the enzyme granulates are worked into a dough mixture.

23. Use according to claim 20, characterized by the fact that the enzyme granulates are used in brewing, in particular to improve the filtration characteristics of the brewing material.

24. Use according to claim 20, characterized by the fact that the enzyme granulates are used in starch liquefaction, in particular in starch liquefaction for the production of alcohol.

25. Use of leguminous flours or of flours from products of the Malvaceae family for the production of enzyme granulates, preferably for the production of enzyme granulates for food technology applications or for working into recipes for food technology applications.
